(19) United States
(12) Patent Application Publication
(10) Pub. No.: US 2009/0221232 A1
(43) Pub. Date: Sep. 3, 2009

(54) Portable Telephone With Unitary Transceiver Having Cellular and RFID Functionality

(76) Inventors: Leonardo W. Estevez, Rowlett, TX (US); Steve Lazar, McKinney, TX (US)

Correspondence Address: TEXAS INSTRUMENTS INCORPORATED, P O BOX 655474, M/S 3999, DALLAS, TX, 75265, US

(21) Appl. No.: 12/040,847

(22) Filed: Feb. 29, 2008

(51) Int. Cl. H04B 5/00

(52) U.S. Cl. 455/41.1

(57) ABSTRACT

An electronic device. The device comprises circuitry for transmitting and receiving radio frequency signals and a modulator/demodulator, coupled to the circuitry for transmitting and receiving. The device also comprises circuitry for controlling the modulator/demodulator so that in a first time period the modulator/demodulator provides an RFID excitation signal to the circuitry for transmitting and receiving and so that in a second time period the modulator/demodulator provides a cellular communications signal to the circuitry for transmitting and receiving.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present embodiments relate to a portable telephone and are more particularly directed to such a device with a unitary transceiver that supports both cellular telephony and radio frequency identification (“RFID”) functionality.

The use of RFID technology is becoming much more prevalent. RIFD is implemented by associating a radio frequency responder or transponder device, often referred to as an RFID tag, typically with an object or objects. Thereafter, an RFID detecting device, sometimes referred to as a reader or scanner, can detect and read information from the RFID tag, if the object(s) and its associated RFID tag are within a perceivable range of the reader. More particularly, the reader transmits a radio frequency signal, and in the common instance where the RFID tag is a passive device, the radio frequency signal is received by an antenna (e.g., coil) of the RFID tag and thereby induces a current that provides sufficient power to temporarily power the RFID tag. With this power, the RFID tag is enabled to communicate a response, and the response may be a unique identifier and, in some instances, additional data stored by the RFID tag. The RFID tag response is therefore read by the RFID reader, thereby concluding the RFID communication event.

The functionality of RFID technology, along with the reduction in price to implement it and the reduction of the size of each RFID tag, have contributed to uses of RFID technology in numerous manners. For example, RFID technology is often used to track movable items, including by ways of example cattle, automobiles, and product inventory. In these and numerous other examples, a tag is associated with each such item, where the tag typically has an associated unique identifier. Thus, as the movable item travels from one location to another, an RFID reader at each such location may detect the presence of the item at the respective location, and that detection may be stored in a computer and the information then or later used for knowing that a given item, identified by its associated unique RFID identifier, has moved from one location to another. At the same time, various other data may be accumulated with respect to timing or conditions at or between the locations and thusly be used for many different purposes.

Given the preceding, and as RFID technology continues to improve, the existence of RFID tags is predicted to become much more pervasive and may impact numerous aspects of society. Indeed, it is quite plausible that such tags may be used to identify items that may raise privacy concerns, and there is ongoing debate whether RFID technology should be used for purposes of tracking people, whether such use be implemented by RFID tags in connection with documents such as passports or as medically-implanted devices. In all events, barring a change in technology, RFID technology may become quite ubiquitous in the foreseeable future.

While RFID technology has proven to have merit in various uses, personal or consumer concern does arise from possible misuse or overuse of RFID technology. Thus, as a counterbalance to the proliferation of RFID technological applications, there may arise an increasing need for persons to be able to monitor the existence of, and data within, any RFID tag in their vicinity or on their person. The preferred embodiments are directed to such an endeavor, as demonstrated below.

### BRIEF SUMMARY OF THE INVENTION

In the preferred embodiment, there is an electronic device. The device comprises circuitry for transmitting and receiving radio frequency signals and a modulator/demodulator, coupled to the circuitry for transmitting and receiving. The device also comprises circuitry for controlling the modulator/demodulator so that in a first time period the modulator/demodulator provides an RFID excitation signal to the circuitry for transmitting and receiving and so that in a second time period the modulator/demodulator provides a cellular communications signal to the circuitry for transmitting and receiving.

Other aspects are also disclosed and claimed.

### BRIEF DESCRIPTION OF THE SEVERAL VIEWS OF THE DRAWING

FIG. 1 illustrates a general diagram of a cellular telephone handset as one preferred embodiment.

FIG. 2 illustrates an electrical block diagram of the construction of an architecture for the handset of FIG. 1.

FIG. 3 illustrates a flowchart of a preferred embodiment operational method for the handset of FIGS. 1 and 2.

FIG. 4 illustrates a block diagram of two different cells CELL 1 and CELL 2, representing cellular areas in which the handset of FIG. 1 may be located at different times along with an RFID tag in CELL 2.

### DETAILED DESCRIPTION OF THE INVENTION

The present invention is described below in connection with a preferred embodiment, namely, implemented as a cellular telephone, which may include functionality beyond cellular communications. The present inventors believe that the invention as embodied is especially beneficial in such an application. However, the invention also may be embodied and provide significant benefit in the form of other devices that have radio frequency transmitters or other transceivers designed for communication at frequencies outside of the radio frequency identification (“RFID”) bands. Accordingly, it is to be understood that the following description is provided by way of example only and is not intended to exhaustively limit the inventive scope.

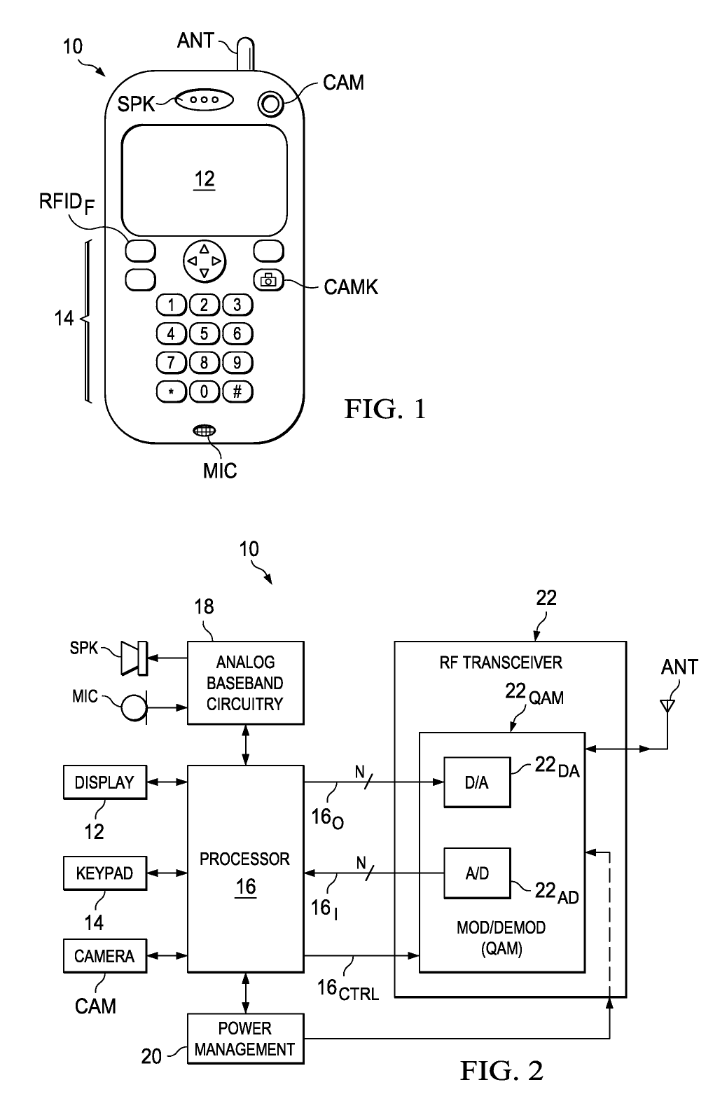

FIG. 1 illustrates a block diagram of a wireless cellular telephone handset 10. The general nature of various aspects of handset 10 is known in the art, but novel aspects are added thereto and improve handset 10 for reasons appreciated throughout the remainder of this document. In the example of FIG. 1, the housing of handset 10 may take the shape of various form factors and provides the conventional human interface voice and sound features, including microphone MIC and speaker SPK. Handset 10 also includes analog baseband circuitry detailed in a later figure. In the preferred embodiment, handset 10 supports digitally modulated communications (e.g., generation 2 or 3), and in such an instance its analog baseband circuitry is therefore primarily concerned with voice baseband signals. In this regard, therefore, the analog baseband circuitry processes the signals to be transmitted (as received from microphone MIC) prior to digital modulation, and the received signals (to be output over speaker SPK) after digital demodulation and, hence into the baseband; further, in an alternative embodiment, the analog baseband circuitry also could be appropriately coupled and configured to support purely analog modulated signals (e.g., generation 1) as well. Additionally, either or both microphone MIC and speaker SPK, and the analog baseband circuitry, may provide functions in addition to telephony, such as in connection with multimedia applications. Such functions may be used for email, Internet web browsing, notification, entertainment, gaming, data input/output, PDA functionality, and the like.

Also in the example of FIG. 1, handset 10 may further include other conventional interface features, including a visual display 12 which may serve solely as an output or which also may include an input functionality such as through a touch screen or write pad functionality, and keypad 14. Keypad 14 includes the usual keys for a wireless telephone handset, including numeric keys 0 through 9, the * and # keys, and other keys as in conventional wireless telephone handsets or that may be included with such handsets, such as soft keys adjacent display 12 as well as directional keys for purposes of navigating a cursor or the like on display 12. Still further in connection with keypad 14, handset 10 is shown to include a camera key CAMK in order to actuate a camera function of handset 10. The lens or other image detecting device of such a camera CAM is illustrated by a dashed circle in FIG. 1 so as to depict, as is often the case in contemporary devices, that camera CAM is on the reverse side of the handset housing shown in FIG. 1 and, thus, is not visible in the frontal perspective of the Figure. Camera CAM may be used for still or video image capture, or both. Lastly, in the preferred embodiment and as detailed below, handset 10 is operable to perform cellular communications as may be implemented in one or more of various technologies known or skilled in the art; however, at the same time, handset 10 is also operable to transmit an RFID signal to thereby excite and scan for any RFID tag within the perceptible vicinity of the handset. In this regard, such functionality may be implemented by a key(s) on keypad 14 and, therefore, by way of example in FIG. 1 one key on keypad 14 is intended to indicate that this key is associated with the RFID functionality of handset 10, which is detailed throughout the remainder of this document. Alternatively, a different key may be used to enable the RFID functionality, or it may occur automatically over a period of time after handset 10 is enabled (e.g., at a fixed or user-selected period or interval), all of which is further appreciated below.

FIG. 2 illustrates an electrical block diagram of the construction of an architecture for handset 10 according to a preferred embodiment. Of course, the particular architecture of a cellular handset (or other wireless communication device within the inventive scope) may vary from that illustrated in FIG. 2, and as such the architecture of FIG. 2 is presented only by way of example. As shown in FIG. 2, the operational functionality of handset 10 is generally controlled in part by a processor 16, that is coupled to visual display 12, keypad 14, camera CAM, analog baseband circuitry 18 as introduced above, and a power management function 20. Processor 16 includes a programmable logic device, such as a microprocessor or microcontroller, that controls the operation of handset 10 according to a computer program or sequence of executable operations stored in program memory. Preferably, the program memory is on-chip with processor 16, but alternatively may be implemented in read-only memory (“ROM”) or other storage in a separate integrated circuit (not shown). The computational capability of processor 16 depends on the level of functionality required of handset 10, including the “generation” of wireless services for which handset 10 is to be capable. As known in the art and mentioned above, modern wireless telephone handsets can have a great deal of functionality (e.g., Internet web browsing, email handling, digital photography, game playing, PDA functionality), and such functionality is in general controlled by processor 16. Processor 16 in a preferred embodiment may include a core and separate digital signal processor (“DSP”), although for simplicity these devices are not separately shown but may be included on a single integrated circuit as a combined processor such as a Texas Instruments Incorporated OMAP™ processor, although other processors/DSPs also may perform the functionality detailed herein. In any event, processor 16, and possibly through its separate DSP component if so included, performs the bulk of the digital signal processing for voice and data signals to be transmitted and signals received by handset 10. These functions include the necessary digital filtering, coding and decoding, digital modulation, and the like. Analog baseband circuitry 18 typically include a voice coder/decoder (“CODEC”), speaker amplifiers, and the like, as known in the art. Power management function 20 includes sufficient circuitry (e.g., amplifier(s)) for distributing regulated power supply voltages to various circuitry within handset 10 and manages functions related to charging and maintenance of the battery of handset 10, including standby and power-down modes to conserve battery power; as detailed below, in one embodiment power management function 20 also may be coupled to a modulator/demodulator so as to regulate power thereto in a manner of providing an amplitude varying (i.e., amplitude modulated) signal for transmission and to thereby potentially activate an RFID tag.

Processor 16 also is coupled to a radio frequency (“RF”) transceiver 22 via an input 16, and an output 16_{O}, where more particularly input 16, receives up to N bits of digital signals from an analog-to-digital converter (“A/D”) 22_{AD} and where output16_{O} provides digital signals to a digital-to-analog converter (“D/A”) 22_{DA}. RF transceiver 22 is coupled to an antenna ANT, and it also may be connected to analog baseband circuitry 18 (although such connection is not shown in FIG. 2). RF transceiver 22 includes functionality for modulating digital data received from processor 16 into an appropriate RF signal for transmission by antenna ANT, and comparably RF transceiver 22 includes functionality for demodulating an RF signal received by antenna ANT to extract the baseband signal therefrom and provide it to processor 16. Further in this regard, such signal communications are made at the desired specified frequencies to and from a wireless telephone communications network. Thus, RF transceiver 22 is contemplated to include such functions as analog modulation/demodulation circuitry such as a quadrature amplitude (“QAM”) modulator/demodulator 22_{QAM} as well as RF input and output drivers. QAM modulator/demodulator 22_{QAM} may be constructed as known in the art to include an appropriate filter, interpolator, upconverter, and the like so as to support QAM operations which provide a carrier signal that is modulated by data to vary both its amplitude (I) and phase (Q) so that at least one of four data symbols can be transmitted and often a greater number for higher quadrature constellations (e.g., 16 QAM, 64-QAM, 128-QAM, and 256 QAM).

Also in the preferred embodiment and as detailed below, processor 16 is also capable of control and communication to and with RF transceiver 22 so as to accomplish the functionality in part of a radio frequency identification (“RFID”) transceiver, and for this and possibly other functionality, processor 16 is also shown to have a control output 16_{CTRL} connected to RF transceiver 22. As introduced above, RF transceiver 22 includes modulator/demodulator 22_{QAM}. Thus, processor 16 is operable to communicate sufficient signals along control 16_{CTRL} and output 16_{OUT} to modulator/demodulator ₂₂_{QAM}, and more particularly data for transmission may be provided to a digital data to D/A converter 22_{DA}, so as to cause RF transceiver 22 to drive antenna ANT with an RFID excitation signal. In this regard, note that for typical cellular communications in QAM, then sufficient data is communicated by processor 16 to RF transceiver 22 and correspondingly to QAM modulator/demodulator 22_{QAM} so as to use both its amplitude (I) and different-phase (Q) carrier waves; however, in a preferred embodiment and so that the same RF transceiver 22 may be used during certain periods of time to implement RFID communications (as opposed to cellular communications), then processor 16 communicates a sufficient signal or signals to RF transceiver 22 (e.g., to digital data to D/A converter 22_{DA}) so as to only use the amplitude portion of QAM modulator/demodulator 22_{QAM}, that is, to only provide a varying amplitude signal—thus, in this case, processor 16 need only provide a signal at output 16_{O} for the pin provided for its I signal and may at that point not provide a signal for the pin provided for its Q signal. In an alternative embodiment, processor 16 may control and/or communicate signals to RF transceiver 22 so as to perform only phase modulation for a period of time in the transmission of a signal to an RFID tag and then thereafter complete the transmission to the tag with amplitude-only modulation. As still another approach, recall that processor 16 is shown as coupled to power management function 20; in this regard, in addition to power control as known in the art, processor 16 may communicate appropriate control to power management function 20 so that it provides power to RF transceiver 22 and more particularly to its QAM modulator/demodulator 22_{QAM} as shown by a dashed arrow in FIG. 2; in this manner by varying the supplied power (i.e., power modulation) a corresponding amplitude modulated signal is caused to be provided by QAM modulator/demodulator 22_{QAM} and communicated to antenna ANT to thereby communicated to a nearby RFID tag. In this regard, note that a preferred embodiment may modulate either the I or Q channel with the data signal. For example, if the Q channel is selected as the channel for modulation, then preferably the I channel is held at a constant value (e.g., 1 or 0). Thus, with any of these approaches, an RFID-excitation signal with the proper energy and frequency may be communicated via antenna ANT. For example, for such an RFID signal in the United States, the frequency thereof will be in a range presently between 902 and 928 MHz. Or, for such an RFID signal in Europe, the frequency thereof will be in a range presently between 856 and 859 MHz. Still further, for such an RFID signal in Japan, the frequency thereof will be in a range presently between 954 and 958 MHz. In any of these case, note that the frequencies for many standard cellular communications (e.g., GSM, CDMA) are around 900 MHz. Thus, per the preferred embodiment, the same transceiver of RF transceiver 22 that is operable to communicate such frequencies for cellular communications is thereby also in effect tunable per the preferred embodiment to synthesize an RFID excitation communication. Also, note in selecting an approach that the advantage of I/Q modulation permits alternate RFID modulation techniques such as Phase Reversal-Amplitude Shift Keying or Phase Modulation or still others ascertainable by one skilled in the art.

In response to an RFID excitation signal by cellular telephone handset 10, and if a nearby RFID tag is energized or otherwise responsive to any of these transmitted signals, then the responsive RFID tag reflection signal is received by antenna ANT and coupled thereby to the RF circuit 20. In this regard, in one preferred embodiment, the responsive reflection signal is in the same band as the transmitted RFID excitation signal, which by way of example consider at 900 MHz. Thus, in this case, both the transmitted excitation signal and the returned reflection signal are 900 MHz. Thus, when such a signal is received by RF transceiver 22, it is demodulated by modulator/demodulator 22_{QAM} and converted by its A/D converter 22_{AD} into an analog baseband signal that is connected to processor 16 via its input 16,. In an alternative embodiment, however, in an effort to improve signal-to-noise sensitivity, the RFID excitation transmission frequency may be different than that of the RFID tag reflected signal. For example, in response to an RFID excitation transmission frequency signal at 900 MHz, particular RFID tags may be constructed to return a reflection signal at a different frequency, such as 860 MHz by way of example. In this manner, while RF transceiver 22 maintains a continuous wave persistence transmission of (i.e., continues to transmit) the RFID excitation transmission signal (e.g., at 900 MHz), then processor 16 may control RF transceiver 22 to be made less sensitive to that same excitation signal by tuning its receiver portion to be sensitive to a reflection at a different frequency (e.g., at 860 MHz). Note that the tuning of the receiving portion of RF transceiver 22 in this alternative embodiment is preferably intermittent or periodic so that RF transceiver 22 is still operable to receive cellular communications at the expected cellular frequency band (e.g., 900 MHz). In other words and as also detailed below, the operation of RF transceiver 22 is effectively time shared or multiplexed in this latter embodiment so that during certain periods of time the receiver is tuned to receive cellular communications (e.g., around 900 MHz in the United States), while during other periods of time the receiver is tuned to receive RFID reflection communications (e.g., around 860 MHz). Preferably, the switching of the receiver sensitivity to different frequencies in this manner will be at a rate that is sufficient to maintain cellular control communication between cellular telephone handset 10 and the tower of the cell within which the handset is then located, while also permitting the reception of reflected RFID signals. Lastly, note further that the RFID excitation signal may also frequency hop to various different frequencies. As with the first receive approach mentioned above, in the alternative approaches again the reflected signal is received by RF transceiver 22, demodulated by modulator/demodulator 22_{QAM} and converted by its A/D converter 22_{AD} into an analog baseband signal that is connected to processor 16 via its input 16_{I}. Note in this regard that preferably the reflected signal is only an amplitude modulated signal, whereas recall that processor 16 is operable (e.g., has pins for) to transmit and receive separate I and Q signals for the cellular QAM operations. Thus, when sampling to determine if an RFID reflection signal has been received by RF transceiver 22, and therefore if processor 16 anticipates receipt of an amplitude-modulated signal, then processor 16 processes only the I signal (e.g., on a pin(s) designated for that signal) and may disregard a concurrently received Q signal (e.g., on a separate pin designated for that signal). In this manner, therefore, processor 16 again may be physically connected to RF transceiver 22 so as to support cellular communications wherein processor 16 both transmits and receives I and Q signals, where with that same physical connectivity processor 16 may alternatively transmit and receive RFID communications as well.

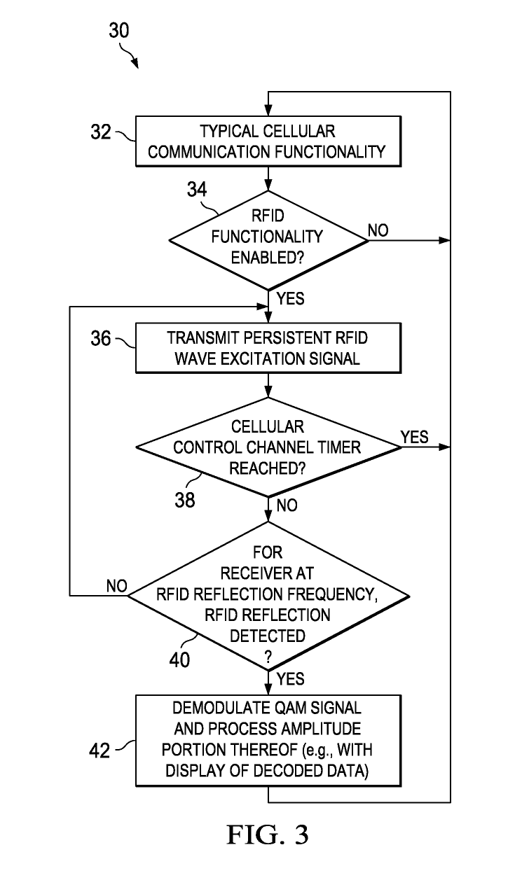

FIG. 3 illustrates a flowchart of a preferred embodiment method 30 of operation for handset 10. Method 30 may be performed by various combinations of software and hardware of handset 10, such as by computer readable media (i.e., programming in program memory) to processor 16 and the circuitry therein, along with resulting response(s) as appreciated below. Further, method 30 only illustrates a portion of the operations of handset 10, as these operations are relevant to the preferred embodiment and may be combined with numerous other functions that are now included or may in the future be included within a device of the type of handset 10.

Looking then to method 30, it is presumed to occur after start-up or initialization or reset of handset 10, and note that method 30 may be combined with other functions known or ascertainable in the art. In any event, method 30 begins with a step 32, wherein handset 10 is shown to perform typical cellular communications. Thus, during periods when no call is occurring, handset 10 may periodically maintain a control channel communication with a cell tower for a cell within which handset 10 is then located. Further, of course, using handset 10, it user may either place or receive a call, or other types of data may be communicated (e.g., email, internet connectivity, and so forth). In any event, during step 32, therefore, processor 16 communicates with and controls RF transceiver 22 so that standard cellular communications occur, such as through whatever type of QAM is thereby required.

Continuing with method 30, the preferred embodiment contemplates that at some point the RFID functionality of handset 10 is enabled. For example, in one preferred embodiment, this enablement may be user invoked, such as by having the user press one or more buttons on keypad 14 (e.g., RFID_{F} in FIG. 1) or through some touch screen entry on display 12. Alternatively, handset 10 may be programmed or otherwise controlled to periodically enable its RFID functionality. In any event, step 34 in effect represents a wait state during typical cellular communications for the RFID functionality of handset 10 to be enabled. In other words, while the typical cellular communication functionality of step 32 is occurring, and if the RFID functionality of handset 10 is not enabled, then method 30 returns in a loop to step 32 so that its cellular functionality continues. However, at some point the RFID functionality is enabled, such as in one of the manners above described, and the enablement is detected by step 34 and in response method 30 continues to step 36.

In step 36, handset 10 transmits an RFID wave excitation signal. This excitation signal is preferably a continuous wave with sufficient persistence so as to excite any RFID tag within the RFID specification vicinity of handset 10. As detailed earlier in connection with FIG. 2, the excitation signal may be generated by processor 16 in various manners, including: (1) causing RF transceiver 22 to provide an amplitude modulated signal using only the I data (or input) of QAM modulator/demodulator 22_{QAM}; (2) performing phase modulation for a period of time in the transmission of a signal to an RFID tag and then thereafter completing the transmission to the tag with amplitude-only modulation; and (3) varying power to RF transceiver 22 so as to cause a respectively transmitted amplitude modulated signal. In any event, during the transmission of step 36, method 30 also continues to step 38.

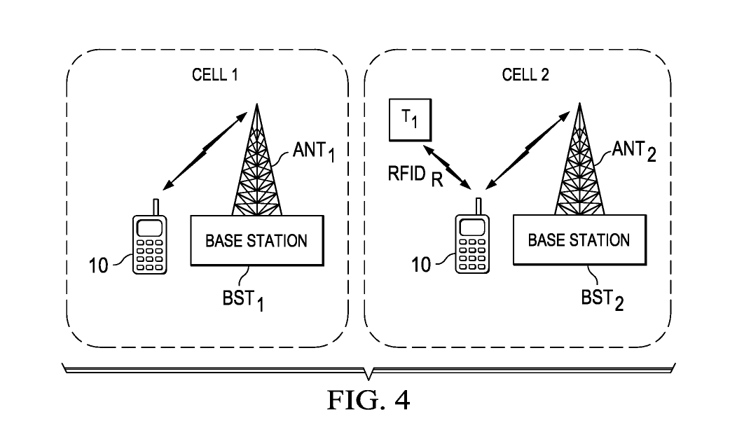

Step 38 has an associated timer from which a determination is made as to whether a timeout period has been reached by that timer, in which case it is desirable to interrupt or stop the transmission of the step 36 RFID excitation signal in favor of maintaining cellular communications. More particularly, since at least portions of the same RF transceiver 22 is used in handset 10 to communicate both an RFID excitation circuit and cellular communications, then the preferred embodiment ensures that sufficient time is reserved for use of that circuit for cellular communications so that the device does not lose communication with the cell tower for a cell within which handset 10 is then located. To illustrate this aspect, FIG. 4 illustrates a block diagram of two different cells CELL 1 and CELL 2, representing cellular areas in which handset 10 may be located at different times, such as if handset 10 were with a user in a mobile environment (e.g., driving in a vehicle). Thus, when handset 10 is in CELL 1, note that per step 32, typical cellular communications occur and thus, handset 10 is able to communicate with an antenna ANT, of a base station BST₁ that corresponds to CELL 1. Moreover, if the user enables the RFID functionality within CELL 1, then step 36 occurs to transmit an RFID wave excitation signal. However, step 38 then permits the excitation signal to occur only for a period of time, where preferably that period is less than the period required for handset 10 to maintain its control channel communication with base station BST₁. In other words, therefore, then in FIG. 4, even if the user of handset 10 enables the RFID functionality, then in a preferred embodiment the timeout period of step 38 attempts to ensure that communications on the control channel between handset 10 and not disrupted or that such disruptions are minimized, as controlled by the duration set with the step 38 timer. Thus, one skilled in the art may set that timer based on various considerations per these teachings as well as other factors. For instance, preferably the step 38 timer when set for a read of an RFID tag (e.g., for a UHF application) would be on for a period of 100 microseconds during each period of 5 milliseconds (or so), so as to allow reading from the tag. Further, during a period in which handset 10 is to write to an RFID tag, the “RFID” on period would be approximately 2 milliseconds. Further, as memory technology improves, these time periods may be reduced. In all events, therefore, and to accomplish the preceding, step 38 determines if its associated timer has reached a determined duration, and if so method 30 returns to step 32 so that typical cellular communications are restored. Further, because handset 10 uses at least a portion of its same RF transceiver 22 to accomplish both RFID and cellular communications, then if method 30 returns to step 32 from step 38, then the RFID transmission that are also achieved using RF transceiver 22 from step 36 is necessarily ceased while instead cellular communications by RF transceiver 22 are performed per step 32. Thus, returning to FIG. 4, if handset 10 is transmitting a continuous RFID wave excitation signal and the step 38 timeout occurs, then handset 10 is then controlled to cease its RFID communications and instead restore cellular communications with base station BST₁. In this manner, the RFID functionality performed using RF transceiver 22 of the preferred embodiment is permitted at certain times but handset 10 is also controlled so as to minimize the potential intrusion of that functionality on typical and often-desired cellular communications.

Returning to step 38, if the timeout is not reached, then while the persistent RFID wave excitation signal continues to transmit (from step 36), method 30 continues to step 40. In step 40, RF transceiver 22 determines whether it is receiving an RFID reflection signal, at an expected frequency. As discussed above, the expected receive frequency may be the same as the RFID transmission frequency (e.g., 900 MHz) or it may be at a receive frequency that differs (e.g., 860 MHz) from the RFID transmission frequency. In either event, if no reflected RFID signal is received, then method 30 returns from step 40 to step 36 so as to maintain the persistent RFID excitation signal transmissions.

From the preceding, note that once the step 36 RFID wave excitation signal transmission commences, then either the timeout of step 38 will return handset 10 to typical cellular functionality of step 32 or eventually step 40 will indeed detect a reflected RFID communication from an RFID tag. To illustrate this latter possibility, FIG. 4 illustrates handset 10 also in CELL 2, wherein handset 10 is represented to be within a detectable RFID range RFID_{R} of an RFID tag T₁ (also referred to in the art as an RFID transponder). Thus, assuming the RFID functionality of handset 10 is enabled when within range RFID_{R} of tag T₁, then in step 40 the RFID signal reflection from tag T₁ is detected by handset 10 and, in response, method 30 continues from step 40 to step 42. In step 42, modulator/demodulator 22_{QAM} demodulates the received signal. Recall, however, that the RFID signal will under present standards include only an amplitude modulated aspect. As a result, as RF transceiver 22 provides the result of its demodulation to processor 16, processor 16 only decodes the demodulated amplitude data and preferably disregards any data or signal that represents the demodulated phase information. In any event, once processor 16 receives the RFID data, it may process it in various manners. In one preferred approach, various information communicated by the RFID tag (e.g., T₁) is provided to the user of handset 10, such as by its display 12. Further, this information may be communicated from handset 10 in a data form to other devices, such as through cellular communications from handset 10 or via any electrical interface that also may be included with the device. Lastly, upon completion of step 42, method 30 returns to step 32 to repeat the various steps and flow possibilities discussed above.

From the preceding, it may be appreciated that the preferred embodiments provide a portable handset that is operable as both a cellular telephone and an RFID reader, where the same RF transceiver in the handset is operable to thereby and alternately communicate both cellular telephone and RFID communications. Moreover, with such circuitry and the functionality of method 30, the preferred embodiments may serve to detect the nearby presence of an RFID tag(s) and provide various information provided by such a tag to the user of the portable handset. Thus, as the use of RFID tags continues to increase, the preferred embodiments may provide various uses to persons with interest or need to detect the existence, and access the information, of such tags, where such uses are evident or ascertainable by one skilled in the art. Further, while FIG. 2 illustrates one approach of a shared RF transceiver implementation, still others may be developed. Still further, note that while a preferred embodiment includes a common RF transceiver to alternately communicate both cellular telephone and RFID communications, in another preferred embodiment an additional and separate RFID transceiver may be included so that a bi-modal functionality is provided. More specifically in this alternative approach, the RF transceiver may be used in one mode and for a first type of RFID communications (as well as alternatively used for cellular communications), while the separate RFID transceiver may be used in a second mode and for a different type of RFID communications. For example, the first type of RFID communications may be applications that require a relatively higher power as compared to the second type of RFID communications; thus, the first type of RFID communications may be to RFID tags that are embedded inside the skin or body of a person (or animal) and which could require, per contemporary standards, a power of approximately 4 Watts, whereas the second type of RFID communications may be merely to RFID tags that are read within a close proximity of handset 10 and with the wireless RFID signal only needing to pass through the air as between handset 10 and the tag, where a power of approximately 200 mWatts is satisfactory. Thus, while the present embodiments have been described in detail, various substitutions, modifications or alterations could be made to the descriptions set forth above without departing from the inventive scope, as is defined by the following claims.

1. A portable electronic device, comprising:
circuitry for transmitting and receiving radio frequency signals;
a modulator/demodulator, coupled to the circuitry for transmitting and receiving; and
circuitry for controlling the modulator/demodulator so that in a first time period the modulator/demodulator provides an RFID excitation signal to the circuitry for transmitting and receiving and so that in a second time period the modulator/demodulator provides a cellular communications signal to the circuitry for transmitting and receiving.

2. The device of claim 1 wherein the modulator/demodulator comprises a quadrature amplitude modulator/demodulator.

3. The device of claim 2:
wherein the quadrature amplitude modulator/demodulator comprises an input for amplitude data and an input for phase data; and
wherein the circuitry for controlling provides data for the input for amplitude data while providing no data for the input for phase data so as to provide the RFID excitation signal.

4. The device of claim 3 wherein the circuitry for controlling provides data for the input for amplitude data and data for the input for phase data during the second time period.

5. The device of claim 3:
wherein the quadrature amplitude modulator/demodulator comprises an output for amplitude data and an output for phase data; and
further comprising circuitry for reading RFID data from the output for amplitude data while not reading data from the output for phase data during at least a portion of the first time period.

6. The device of claim 5 and further comprising circuitry for reading cellular communications data from the output for amplitude data and the output for phase data during the second time period.

7. The device of claim 2:
wherein the quadrature amplitude modulator/demodulator comprises an input for amplitude data and an input for phase data; and
wherein in a first time period the circuitry for controlling provides data for the input for phase data while providing no data for the input for amplitude data; and
wherein in a second time period following the first time period, the circuitry for controlling provides data for the input for amplitude data while providing no data for the input for phase data so as to provide the RFID excitation signal.

8. The device of claim 1 and further comprising circuitry for limiting a duration of the first time period.

9. The device of claim 1:
wherein the circuitry for transmitting is for transmitting the RFID excitation signal at a first frequency during the first time period; and
wherein the circuitry for receiving is for receiving an RFID reflection signal at a second frequency, different than the first frequency, during the first time period.

10. The device of claim 1:
wherein the modulator/demodulator comprises an input for receiving a power supply to supply power to the modulator/demodulator; and
wherein the circuitry for controlling provides a varying amount of power to the input for receiving a power supply during at least a portion of the first time period so that the modulator/demodulator provides the RFID excitation signal in response to the varying amount of power.

11. The device of claim 1 wherein the circuitry for receiving radio frequency signals comprises circuitry for receiving RFID signals.

12. The device of claim 11 wherein the modulator/demodulator is operable to demodulate the RFID signals.

13. The device of claim 12 and further comprising circuitry for decoding a signal from the demodulator and corresponding to the RFID signals.

14. The device of claim 13 and further comprising circuitry for displaying information in response to the RFID signals.

15. The device of claim 11 and further comprising circuitry for displaying information in response to the RFID signals.

16. The device of claim 1 wherein the circuitry for receiving radio frequency signals comprises circuitry for receiving RFID signals by frequency hopping to different frequencies along which the RFID signals may be communicated.

17. The device of claim 1 wherein the circuitry for controlling comprises a digital signal processor.

18. The device of claim 1 and further comprising circuitry for transmitting an RFID communication signal to an RFID tag; and
wherein the circuitry for controlling is further for controlling the circuitry for transmitting an RFID communication signal in a third time to communicate the RFID communication signal.

19. The device of claim 18:
wherein the circuitry for transmitting and receiving radio frequency signals is for communicating an RFID communication signal at a first power level in response to the RFID excitation signal;
wherein the circuitry for transmitting an RFID communication signal is for communicating an RFID communication signal at a second power level; and
wherein the first power level is greater than the second power level.
